(19) United States
(12) Patent Application Publication
(10) Pub. No.: US 2008/0062514 A1
(43) Pub. Date: Mar. 13, 2008

(54) DIGITAL TELESCOPIC SIGHT

(75) Inventors: Chia-Chun Chang, Taipei (TW); Chen-Yeh Lin, Taipei (TW)

Correspondence Address: MADSON & AUSTIN, 15 WEST SOUTH TEMPLE, SUITE 900, SALT LAKE CITY, UT, 84101, US

(73) Assignee: Asia Optical Co., Inc., Taichung (TW)

(21) Appl. No.: 11/669,332

(22) Filed: Jan. 31, 2007

(30) Foreign Application Priority Data
Sep. 8, 2006 (TW) 095133365

(51) Int. Cl. G02B 23/00

(52) U.S. Cl. 359/399; 359/431

(57) ABSTRACT

A digital telescopic sight includes an objective lens group (202), a light collecting lens (204), an erecting lens group (206), an eyepiece lens group (212), a semi-reflecting mirror (208) and an image sensor (210). The incident exterior light rays are sequentially transmitted through the objective lens group, the light collecting lens and the erecting lens group, and then incident onto the semi-reflecting mirror. The semi-reflecting mirror reflects a portion of the light rays onto the image sensor, and transmits the remaining primary light rays to the eyepiece lens group for enabling the user to view the image. The image sensor receives the reflected portion of the light rays, converts it into an electrical signal, and finally transmits the electrical signal to a digital signal processor for further image signal processing.

### BACKGROUND OF THE INVENTION

1. Field of the Invention

The present invention relates to a digital telescopic sight, and particularly relates to a digital telescopic sight that employs a semi-reflecting mirror to reflect a portion of the light rays onto an image sensor thereof.

2. Description of Prior Art

FIG. 1 is a schematic view illustrating the component configuration of an optical system for a conventional digital telescopic sight. This optical system primarily includes an objective lens group 102, a light collecting lens 104, an erecting lens group 106, an eyepiece lens group 112, a refracting prism 108 and an image sensor 110. The refracting prism 108 is adapted to refract a portion of the light rays along a primary optical axis O′A′ of the optical system onto the image sensor 110. The image sensor 110 may be in the form of a CMOS (Complementary Metal-Oxide Semiconductor) sensor or a CCD (Charge Coupled Device) sensor. The image sensor 110 then receives this portion of refracted light rays along the primary optical axis O′A′, converts it into an electrical signal, and finally transmits the electrical signal to a Digital Signal Processor (DSP) (not shown) for further image signal processing.

However, the refracting prism 108 is complex in structure, high in cost, and heavy in weight. Therefore, incorporation of a refracting prism in the conventional digital telescopic sight increases the weight of the telescopic sight, complicates the configuration of the telescopic sight, and increases the manufacturing costs.

Accordingly, to overcome the above disadvantages present of the prior art, it is desired to provide a digital telescopic sight with reduced weight and manufacturing cost while without compromising optical performance.

### SUMMARY OF THE INVENTION

An object of the present invention is to provide a digital telescopic sight that utilizes a semi-reflecting mirror to reflect a portion of the light rays onto an image sensor thereof, so that the weight and manufacturing cost of the digital telescopic sight are decreased.

To achieve the above object of the present invention, a digital telescopic sight in accordance with the present invention includes an objective lens group, a light collecting lens, an erecting lens group, an eyepiece lens group, a semi-reflecting mirror and an image sensor. The incident exterior light rays are sequentially transmitted through the objective lens group, the light collecting lens and the erecting lens group, and then incident onto the semi-reflecting mirror. The semi-reflecting mirror reflects a portion of the light rays onto the image sensor, and transmits the remaining primary light rays to the eyepiece lens group for enabling the user to view the image. The image sensor receives the portion of the light rays reflected by the semi-reflecting mirror, converts it into an electrical signal, and finally transmits the electrical signal to a Digital Signal Processor (DSP) (not shown) for further image signal processing. The semi-reflecting mirror is formed by providing a semi-reflecting metal film on a planar mirror by means of vacuum sputtering, vapor deposition or coating. The planar mirror is made of a transparent glass or plastic material.

The present digital telescopic sight employs a semi-reflecting mirror to reflect a portion of the light rays along the primary optical axis onto the image sensor. In comparison with the conventional digital telescopic sight that employs a refracting prism, the weight and manufacturing cost of the present digital telescopic sight are reduced while without compromising the optical performance of the present digital telescopic sight. Accordingly, the present digital telescopic sight has an increased range of applicability in comparison with the conventional design.

### BRIEF DESCRIPTION OF THE DRAWINGS

The present invention may best be understood through the following description with reference to the accompanying drawings, in which:

FIG. 1 is a schematic view illustrating the component configuration of a conventional digital telescopic sight; and

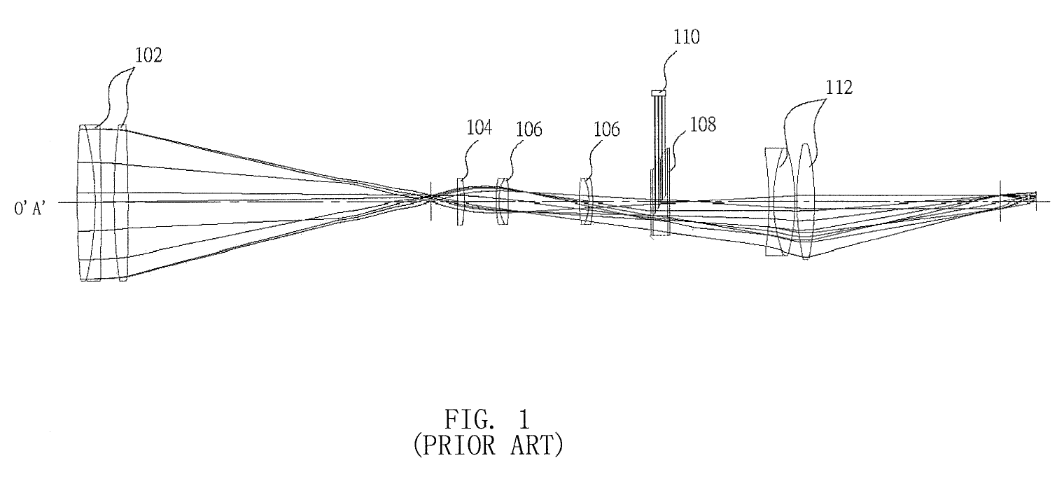

FIG. 2 is a schematic view illustrating the component configuration of a digital telescopic sight in accordance with the present invention.

### DETAILED DESCRIPTION OF THE PREFERRED EMBODIMENT

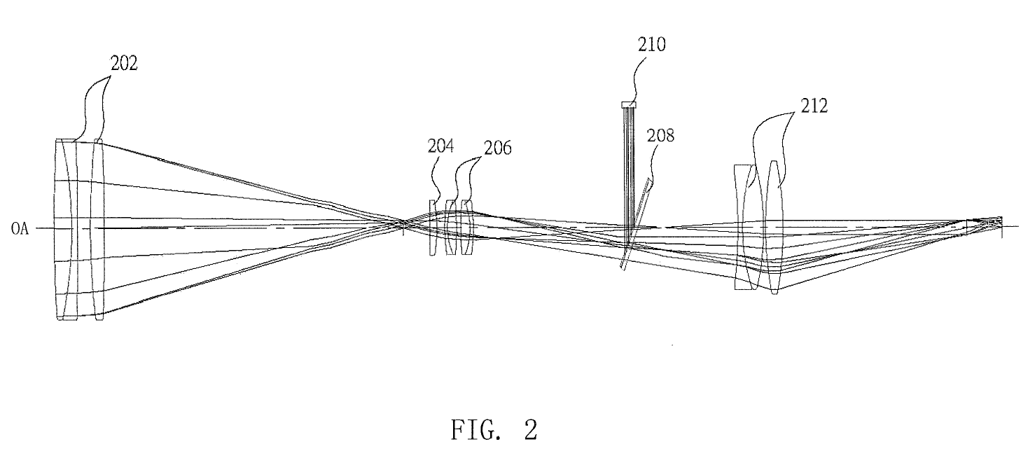

FIG. 2 is a schematic view illustrating the component configuration of a digital telescopic sight in accordance with the present invention. As shown in FIG. 2, the present digital telescopic sight includes an objective lens group 202, a light semi-reflecting mirror 208 and an image sensor 210. The objective lens group 202, the light collecting lens 204, the erecting lens group 206, the semi-reflecting mirror 208 and the eyepiece lens group 212 are sequentially arranged along the direction in which exterior light rays enter the digital telescopic sight or along the primary optical axis OA of the digital telescopic sight. In detail, the objective lens group 202 is positioned at an object end or the frontmost end of the digital telescopic sight. The light collecting lens 204 is positioned on one side of the objective lens group 202. The erecting lens group 206 is positioned on one side of the light collecting lens group 204 opposite to the objective lens group 202. The semi-reflecting mirror 208 is positioned on one side of the erecting lens group 206 opposite to the light collecting lens group 204. The eyepiece lens group 212 is positioned on one side of the semi-reflecting mirror 208 opposite to the erecting lens group 206. The image sensor 210 is positioned on one side of the semi-reflecting mirror 208 in a direction perpendicular to the direction in which the exterior light rays enter the digital telescopic sight or the primary optical axis OA of the digital telescopic sight.

The incident exterior light rays are sequentially transmitted through the objective lens group 202, the light collecting lens 204 and the erecting lens group 206, and then incident onto the semi-reflecting mirror 208. The semi-reflecting mirror 208 reflects a portion of the exterior light rays onto the image sensor 210, and transmits the remaining primary light rays to the eyepiece lens group 212 for enabling the user to view the image. The image sensor 210 receives the portion of the light rays reflected by the semi-reflecting mirror 108, converts it into an electrical signal, and finally transmits the electrical signal to a Digital Signal Processor (DSP) (not shown) for further image signal processing. The semi-reflecting mirror 208 is formed by providing a semi-reflecting metal film on a planar mirror by means of vacuum sputtering, vapor deposition or coating. The planar mirror is made of a transparent glass or plastic material.

The present digital telescopic sight employs a semi-reflecting mirror 108 to reflect a portion of the exterior light rays along the primary optical axis OA onto the image sensor 210. In comparison with a conventional digital telescopic sight that employs a refracting prism to refract a portion of the exterior light rays onto the image sensor, the present digital telescopic sight has a significantly reduced weight since a semi-reflecting mirror is much lighter than a refraction prism. Further, the structural design for a digital telescopic sight with a semi-reflecting mirror is easier than that for a digital telescopic sight with a refracting prism. In addition, the application of a semi-reflecting mirror instead of an expensive refracting prism effectively reduces the manufacturing cost of the present digital telescopic sight. However, the optical performance of the present digital telescopic sight is not sacrificed. Accordingly, the present digital telescopic sight has an increased range of applicability in comparison with the conventional design.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A digital telescopic sight, comprising:
an objective lens group positioned at one end of the digital telescopic sight;
a light collecting lens positioned on one side of the objective lens group;
an erecting lens group positioned on one side of the light collecting lens opposite to the objective lens group;
a semi-reflecting mirror positioned on one side of the erecting lens group opposite to the light collecting lens;
an eyepiece lens group positioned on one side of the semi-reflecting mirror opposite to the erecting lens group; and
an image sensor receiving exterior light rays reflected from the semi-reflecting mirror;
wherein the exterior light rays incident into the digital telescopic sight are sequentially transmitted through the objective lens group, the light collecting lens and the erecting lens group, and then incident onto the semi-reflecting minor; and wherein the semi-reflecting minor reflects a portion of the light rays onto the image sensor, and transmits the remaining light rays to the eyepiece lens group.

2. The digital telescopic sight as claimed in claim 1, wherein the semi-reflecting mirror is formed by forming a semi-reflecting metal film on a planar mirror by vacuum sputtering, vapor deposition or coating.

3. (canceled)

4. The digital telescopic sight as claimed in claim 2, wherein the planar mirror is made of glass.

5. The digital telescopic sight as claimed in claim 2, wherein the planar mirror is made of plastic.

6. The digital telescopic sight as claimed in claim 1, wherein the image sensor is a CMOS (Complementary Metal-Oxide Semiconductor) sensor.

7. The digital telescopic sight as claimed in claim 1, wherein the image sensor is a CCD (Charge Coupled Device) sensor.
